(19) United States
(12) Patent Application Publication
(10) Pub. No.: US 2004/0074240 A1
(43) Pub. Date: Apr. 22, 2004

(54) Cryogenic Liquid delivery system with micropopous phase separator

(76) Inventors: Mark Robbie, Livingston (GB); Andrew Aitken, Edinburgh (GB)

Correspondence Address: Carol A Lewis White, W L Gore & Associates Inc, 551 Paper Mill Road, Newark, DE, 19714-9206, US

(21) Appl. No.: 10/250,978

(22) PCT Filed: Jan. 14, 2002
(86) PCT No.: PCT/GB02/00121

(30) Foreign Application Priority Data
Jan. 13, 2001 (GB) 0100994.3

(51) Int. Cl. F17C 7/02; F25B 19/00

(52) U.S. Cl. 62/50.1; 62/51.1

(57) ABSTRACT

An improved cryogenic fluid delivery system is disclosed that employs a closed microporous tube as a transfer conduit coupled to the outlet of a cryogenic fluid container, such as a Dewar. The microporous transfer conduit preferentially draws liquid through its microporous wall structure, simultaneously filtering impurities from the fluid.

### FIELD OF THE INVENTION

The present invention relates to devices for the transfer of cryogenic fluids.

### DESCRIPTION OF RELATED ART

A wide variety of tubes and pipes are used to deliver liquids. Given that such tubes are not intended to leak, they are typically non-porous. Accordingly, dip tubes of the prior art deliver liquid only if the open end of the tube is submerged in the associated liquid reservoir. Consequently, the tubes cannot deliver liquid in cases in which the open end of the tube loses contact with the liquid due to movement of the tube. The same failure to deliver liquid arises in cases in which the tubes are fixed in position yet the liquid reservoirs are inverted or the liquid level shifts due to movement of the reservoir. These situations arise in applications such as portable cryogenic Dewars.

U.S. Pat. No. 3,572,048 (The Wiremold Company) addresses the problems of multi-orientational liquid cryogen pick-up and the maintenance of a suitable composition of breathing air by ensuring that only liquid air is fed to a heat exchanger-vaporizer system. Liquid pick-up is achieved by two weighted pivoted pick-ups positioned at the extremities of the storage tank, the pivots consisting of springy coiled conduit. A gravity actuated transfer valve blocks the flow of the gas phase into the heat exchanger when the associated pick-up is not covered by liquid.

U.S. Pat. No. 3,699,775 (Sub-Marine Systems Incorporated) describes an arrangement for use in underwater breathing apparatus, including a stainless steel cloth conduit for transporting liquid cryogen from a tank in a non-upright orientation.

Another patent, U.S. Pat. No. 5,357,758 to Martin D. Andonian, relates to an “all position cryogenic liquefied-gas container”; however, it does not address the problem of all-position accessing of liquid cryogen and only gives regular gas flow in all positions. Through a series of control valves and heat exchangers plus top and bottom exits from the Dewar, it provides a substantially constant flow of gas on demand.

U.S. Pat. No. 5,361,591 (Oceaneering Int. Inc.) describes a system for providing cooling and breathable atmosphere to the wearer of a garment or suit from liquid cryogen. The patent concentrates on a control system for heat exchange and breathing atmosphere but also addresses the problem of user orientation by using a piston fitted within the Dewar to positively displace the liquid cryogen above the piston. The piston is pressurized from underneath by evaporated cryogen. Control of the pressure below the piston ensures that there is no gas phase above it and hence only liquid exits the Dewar.

This is a complex system involving evaporators, control valves and regulators to give a stable flow of liquid from the Dewar. U.S. Pat. No. 5,365,745 (Oceaneering Int. Inc.), a continuation-in-part of this patent, adds no new matter regarding the multi-orientational Dewar. The multi-orientational capability is achieved by positive displacement techniques as in the previous patent. A refinement to the Dewar is added in the form of rubber bellows on the gas-phase side of the piston, which allows the lower part of the Dewar to be water charged so that when the system is used underwater the buoyancy balance of the wearer is not upset as the liquid cryogen is used up. The bellows prevent contamination of the Dewar and limit warming of the cryogenic liquid in the upper part of the Dewar.

U.S. Pat. No. 5,438,837 (Oceaneering Int. Inc.) relates to a Dewar for storing and delivering cryogen to a life support system. The Dewar can deliver liquid and vent gas in multiple orientations. The Dewar is claimed to have a “rapid fill” facility and also has a capacitance gauge to monitor the liquid level in the Dewar.

The operation of the Dewar relies on a system of freely rotating conduits, one of which acts as a vent and another which acts as a liquid delivery tube. The liquid delivery conduit has at its extremity a section of conduit which is hinged at right angles to the main section of conduit and orientates under the influence of gravity so as to be immersed in the liquid, which also is free to move under the influence of gravity within the Dewar. The vent conduit is attached to the liquid delivery conduit in such a manner so as always to be displaced 180 degrees from the extremity of the liquid delivery conduit, thus ensuring that the open end of the vent conduit is always in the gas phase within the Dewar. Both conduits are attached, through a hub, to rotating couplings which connect with further conduits that exit the Dewar.

The system can only work if the Dewar is in the form of a cylinder where the diameter is greater than the height or truncated sphere with the conduits pivoted about the minor axis of the cylinder or sphere.

U.S. Pat. No. 6,012,453 (Figgie International) describes an apparatus for withdrawing liquids from a closed container independent of the spatial orientation of the container. The system uses one or more flexible conduits suspended within the container which have perforated spheres attached to their ends, which may be weighted. To ensure submersion in the liquid, the perforated spheres may be filled with wicking material, which helps to draw the liquid into contact with the conduit end regardless of the liquid level in the container or the orientation of the container. The specification addresses the problem of ensuring that breathing air be drawn from the liquid phase in the container and preferably selects PTFE tubes of 0.030 inch (0.762 mm) diameter with 0.006 inch (0.1524 mm) to 0.010 inch (0.254 mm) walls as the conduit dimensions. The reference only teaches the use of open-ended tubes covered at their ends with the perforated spheres. No mention is made of the use of porous tubes.

Non-porous tubes with open ends have been adapted for use in liquid containers to deliver liquid regardless of the position of the container. Commonly the tubes are flexible and the ends of the tubes are weighted so that the end of the tube remains in the liquid.

None of the above references addresses or discloses the use of polymeric porous or closed-end tubes to deliver cryogenic liquids. Furthermore, none of the references describes a cryogenic liquid delivery tube that also serves to filter the liquid.

### SUMMARY OF THE INVENTION

One aspect of the present invention comprises a system for the transfer of cryogenic liquids that employs a microporous shaped article within a container and connected to an outlet of the container. Cryogenic liquid is drawn from a container into the microporous shaped article through the microporous structure of the shaped article. With the shaped articles of this invention, cryogenic liquid can be effectively transferred through a wide range of attitudes of the liquid container, as the microporous shaped articles will deliver cryogenic liquid when any portion of the microporous shaped article remains in contact with the liquid. Additionally, the microporous structure of the shaped article also serves to filter the cryogenic liquid during transfer.

The preferred microporous shaped articles comprise articles constructed from expanded polytetrafluoroethylene (ePTFE) which include a microstructure of polymeric nodes and fibrils. Expanded PTFE is inert, flexible, and highly durable, even at very low temperatures, making it suitable for use with a wide variety of liquids under a wide range of operating conditions. This system of cryogenic liquid transfer is particularly suited for use with Dewars, such as those employed in self-contained breathing apparatus and environmental suits. Other suitable containers may be used for alternative applications.

Microporous shaped articles employed in the present invention may take many forms such as, but not exclusive to, tubes, bladders, beads, and two or more co-axial cylinders or tubes defining at least one annulus therebetween. Additionally the microporous shaped articles may be microporous throughout their entire structure or may only be microporous in part or parts of their structure; being non-porous or macroporous in the remainder of their structure.

### DESCRIPTION OF THE DRAWINGS

The operation of the present invention should become apparent from the following description when considered in conjunction with the accompanying drawings, in which:

FIG. 1 is a schematic front elevation view of a first embodiment of a fluid transfer system of the present invention, employing a Dewar and in which the microporous shaped article is in the form of U-tube with one end closed;

FIG. 2 is a schematic front elevation view of a second embodiment of a fluid transfer system of the present invention;

FIG. 3 is a schematic front elevation view of a third embodiment of a fluid transfer system of the present invention;

FIG. 4a is a schematic front elevation view of another Dewar embodiment of the present invention;

FIG. 4b is a schematic front elevation view of yet another Dewar embodiment of the present invention;

FIG. 5a is a schematic front elevation view of a Dewar embodiment of the present invention in which the microporous shaped article in the form of a tube is arranged in random orientation within the Dewar;

FIG. 5b is a schematic front elevation view of a Dewar embodiment of the present invention in which the microporous shaped article is in the form of a tube arranged in a spiral within the Dewar; and

FIG. 6 is a schematic part-sectional view of microporous beading of the present invention in an arrangement for testing the beading for use as a cryogenic liquid transfer device.

### DETAILED DESCRIPTION OF THE INVENTION

The preferred embodiment of the present invention employs a microporous shaped article in the form of a tube for the delivery of cryogenic liquids, particularly a microporous tube that delivers a liquid even when only a portion of the tube is in contact with the liquid and the remainder of the tube is surrounded by gas. The tube also delivers liquids under these conditions when it is closed-ended. The surprising feature of the microporous tube is that it preferentially delivers liquid, rather than gas, even when a portion of the tube is not submersed in liquid. Liquid can enter the tube wherever the tube has the appropriate pore structure. The microporous nature of the tube enables it to further act as a liquid filter device.

The microporous tube may also have attached to it or in contact with it, internally, externally, or both, support members or stiffening members such as springs, wires, polymer beads, rings, or other suitable constructions which would act to maintain the position of the tube within the Dewar. The tube may be provided in combination with one or more additional coaxial tubes.

“Cryogenic” in this context is meant to describe physical conditions where temperature is less than approximately 123 K. A “cryogenic fluid” may be defined as a fluid whose temperature is less than approximately 123 K and which boils at temperatures less than approximately 123 K (−150 C) at atmospheric pressure. A cryogenic fluid may therefore be either a gas or a liquid. By “cryogen” in this context is meant a cryogenic fluid. Cryogenic fluids include, but are not limited to, liquid nitrogen, liquid air, and liquid argon.

By “microporous” is meant that the morphology of a porous material is such that the pores are not normally visible to the naked eye.

By “macroporous” is meant that the morphology of a porous material is such that the pores are normally visible to the naked eye.

By microporous bead or beading is meant an article that is substantially microporous throughout its cross-section, such cross-section being circular, semi-circular, triangular, square, or any other suitable geometric shape.

By “Dewar” in this context is meant an insulated container used to store cryogenic liquids.

In one embodiment of the present invention, the tube serves as a dip tube in a cryogenic liquid storage and delivery Dewar. Even if the tube is microporous along its entire length and only a portion of the tube is in contact with the liquid, liquid will flow through the tube and exit the Dewar. A coiled or spiraled tube, therefore, can be placed inside a Dewar such that a portion of the tube is always in contact with the liquid, so that the tube delivers the liquid regardless of the attitude of the Dewar. The Dewar may be replaced by an uninsulated container for other applications, as appropriate.

Liquid flow from the Dewar is achieved by generating a positive pressure differential between the interior of the Dewar and the exit port of the outlet tube. Such positive pressure differential may be generated by the evaporation of the cryogenic liquid inside the sealed Dewar, by introducing pressurised gas into the Dewar, by supplying pressure from a pump to the interior of the Dewar or by providing a lower pressure at the outlet using a vacuum pump.

By “dip tube” in this context is meant a tube that extends into a fluid reservoir for the purpose of delivering the fluid out of the reservoir.

By “a closed end” is meant an end that is not open. By an “open end” is meant an end of a tube that has less restriction to fluid flow entry than through the wall of the tube. For instance, a porous tube is considered to have an open end if a fluid can pass through that end of the tube with a lower motivating force than is required to pass the same fluid through the wall of the tube. The end of a porous tube, therefore, may be capped with a mesh or filter or the like and still be considered to be open provided that the resistance to flow through the end of the tube is less than that through the wall of the tube.

In another embodiment of the invention, the liquid and gas are present inside the tube. The liquid is forced through the wall to the outside of the tube by the application of a suitable motivating force, such as by pressurizing the fluid inside the tube or by providing a vacuum to the outside of the tube.

Various materials, such as paper and porous metal (e.g., brass), may be used to construct tubes of the present invention. Expanded PTFE microporous materials are particularly well suited because of their chemical resistance properties, flexibility, strength, and large operating temperature range. These attributes make them even more useful for the delivery of cryogenic liquids.

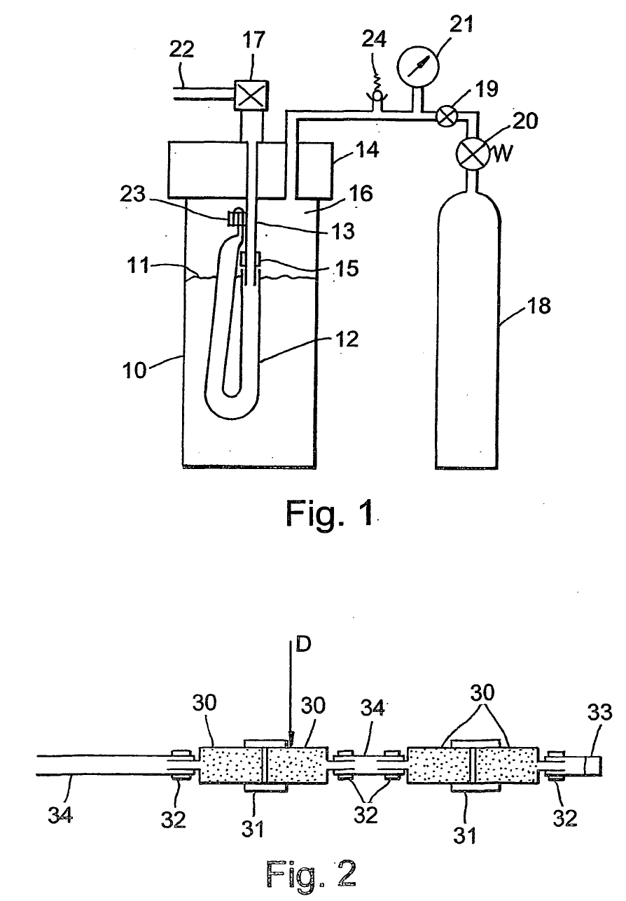

Tubes are tested in the apparatus depicted in FIG. 1. A Dewar 10 (500 ml, Cryomedical Instruments, Ltd., U.K.) is approximately half-filled with liquid nitrogen (hereinafter referred to as “LN2”) 11. A tube 12 to be tested is connected with a clamp 15 to a stainless steel tube 13 extending from the bottom of the Dewar cap 14. The end of the tube is folded over and sealed with a clamp 23. Each tube is positioned such that a portion of the tube is submerged in the LN2 and the remainder lies within gaseous nitrogen 16. The Dewar cap is securely screwed onto the Dewar container. The on-off flow control valve 17 is opened. External pressure is applied to the gaseous space above the LN2, the ullage space, via a compressed air tank 18. The air supply valve 19 is opened and the air tank regulator 20 is adjusted to provide a pressure between 350 and 400 mbar, as measured by the pressure transducer 21. A pressure relief valve 24 is included in the circuit for safety reasons. Flow of LN2 is detected by placing a sheet of paper directly in front of the exit port 22 and examining the paper for any evidence of wetting by LN2. A variety of tubes are tested in this manner.

Although these tests utilised a Dewar, any container suitable for use with cryogenic fluids may also be used.

Tubes constructed from various porous polymeric, metallic, and other materials may be used. These materials include, but are not limited to, microporous polyethylene, microporous sintered metals, microporous ceramics, and paper.

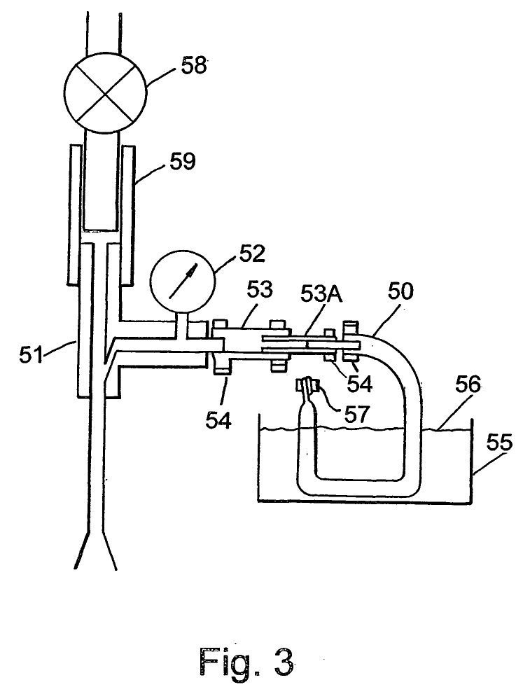

Tubes are also tested in which the pressure driving force is provided by drawing a vacuum inside a tube 50 as depicted in FIG. 3. The vacuum is created using a water jet suction pump (Bilby Sterling Ltd., Stone, Staffs, England) that is connected to a faucet 58 using a rubber hose faucet adapter 59. The vacuum is measured with a vacuum gage 52. Clear plastic tubing 53 (9.5 mm outer diameter, 6.5 mm inner diameter; Tygon, McMaster Carr, Santa Fe Springs, Calif.) and 53A (Copely Developments Ltd., Leicester, England) connects the tube 50 to the suction jet pump. The connections are secured with stainless steel clamps 54. Liquid nitrogen 56 is contained in an open Dewar 55 and the tube 50 is positioned into a loop as shown FIG. 3 such that 155 mm of the 315 mm length is immersed in LN2. The flow of LN2 through the tube is determined by watching for the liquid in the clear tubing 53. Liquid nitrogen delivery is observed when the end of the tube is folded over and secured with a clamp 57 and when left open.

Rather than a water jet suction pump, the motivating pressure may be applied via a vacuum pump or any suitable pressure source, including but not limited to, an external pump, the pressure generated by the boiling cryogen, and the use of a piston for compressing the fluid.

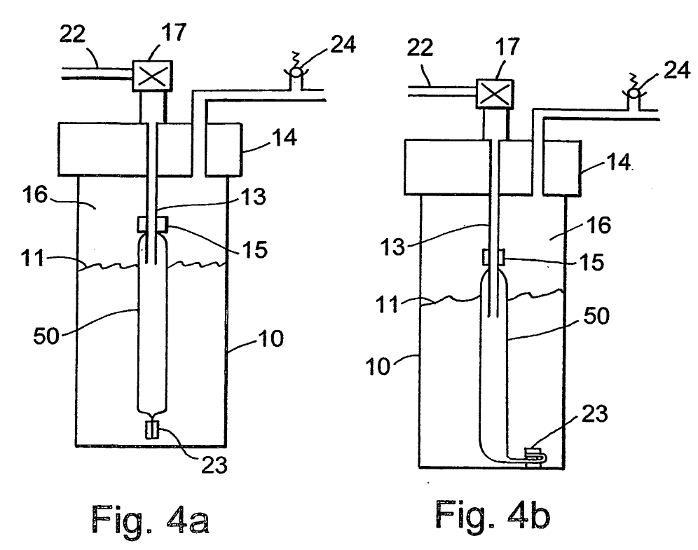

Tubes are also tested in different positions using the same test apparatus of FIG. 1. Tubes are tested when hanging straight from the stainless steel tube 13 as depicted in FIG. 4a and when resting at the bottom of the Dewar 10 as depicted in FIG. 4b.

The tube may contain non-porous or macroporous sections, provided that the microporous sections maintain contact with the cryogenic liquid. Provided that any suitably porous section of the tube is in contact with the cryogenic liquid, the tube serves to deliver the cryogenic liquid. Various configurations of the tube may be employed to ensure that the tube maintains contact with the liquid. Such configurations include, but are not limited to, coiling, spiraling, arranging in manifolds, and the like. In addition the end of the tube may be weighted.

The tube preferably possesses the same pore structure along its length, is flexible and is closed-ended.

It will be obvious to one skilled in the art that appropriate combinations of tube material, tube diameter, tube length, and lengths of porous sections of the of the tube can be chosen to provide a tube that will perform as intended and, without intending to limit the scope of the present invention, the following examples illustrate how the present invention can be made and practised:

### EXAMPLE 1 (a)

Expanded PTFE film is obtained possessing a thickness of 0.08 mm, an isopropanol bubble point of 0.12 MPa and a Gurley number of 15.1 seconds. Film thickness is measured with a snap gauge (such as Model 2804-10 Snap Gauge available from Mitutoyo, Japan). Bubble point of films is measured according to the procedures of ASTM F31 6-86. The film is wetted with isopropanol (IPA). The resistance of samples to airflow is measured by a Gurley densometer, such as that manufactured by W. & L. E. Gurley & Sons, in accordance with conventional measurement procedures, such as those described in ASTM Test Method D726-58. The results are reported in terms of Gurley Number, or Gurley-Seconds, which is the time in seconds for 100 cubic centimetres of air to pass through 1 square inch of a test sample at a pressure drop of 4.88 inches of water. This ePTFE film is then circumferentially wrapped over a 3.2 mm diameter, 900 mm long, stainless steel mandrel such that the width of the film is laid up approximately parallel to the length of the resultant tube. Eighteen layers of film are wrapped around the mandrel. The cross-sectional geometry of the layered tube construction is spiral-shaped.

The ends of the layered film and base tube construction are restrained by clamping means to prevent shrinkage in the longitudinal direction of the construction (the longitudinal axis of the mandrel) during subsequent heat treatment.

The restrained tube construction is submerged in a 385° C. conduction oven for 8.0 minutes in order to bond the ePTFE layers and impart dimensional stability to the tube. The tube is allowed to cool. The clamps are removed and the tube is removed over the end of the mandrel. The tube length is about 680 mm. The outer diameter is 4.98 mm and the wall thickness is 0.89 mm.

The tube is prepared for testing as described above and as illustrated in FIG. 1. The length of the tube 12 between the end clamp 23 and the seal 15 to the stainless steel tube 13 attached to the Dewar cap is 325 mm. The tube is positioned into a loop as depicted in FIG. 1.

With the flow control valve 17 in the open position, the ullage gas pressure is increased to between 350 and 400 mbar. Flow of LN2 is confirmed by the wetting of the paper in front of the exit port.

### EXAMPLE 1 (b)

A length of tubing of a 5 mm thin-walled GORE-TEX® Vascular Graft (item VT05100L, lot #315850BA-046, W.L. Gore and Associates, Inc.) is obtained. The outer diameter is approximately 5.78 mm and the wall thickness is approximately 0.39 mm. The tube 12 is prepared for testing as described above. The length of the tube between the end clamp 23 and the seal 15 to the stainless steel tube 13 attached to the Dewar cap is 325 mm. The tube is positioned into a loop as depicted in FIG. 1.

With the flow control valve 17 in the open position, the ullage is pressurised between 350 and 400 mbar. Flow of LN2 is confirmed by the wetting of the paper in front of the exit port.

Another length of the same type of tubing, 5 mm thin-walled GORE-TEX® Vascular Graft (item VT05100L, lot #315850BA-047, W.L. Gore and Associates, Inc.) is obtained. This tube is tested as described above except the tube is positioned as depicted in FIG. 4B. Flow of LN2 is confirmed by the wetting of the paper in front of the exit port. The test is continued until all of the LN2 is removed from the Dewar.

### EXAMPLE 1 (c)

A tube is constructed from a sheet of paper (Guilbert Niceday, Ltd., Andover, England) possessing a thickness of 0.07 mm. The sheet is rolled into a tube, rolling from the lengthwise edge. A tube 12 is constructed of seven layers and constrained in that shape by helically wrapping PTFE sewing thread (RASTEX®, Part Number S012T1, W.L. Gore and Associates, Inc., Elkton, Md.) once up and down the length of the tube. The distance between consecutive wraps is about 8 mm. The outer diameter is approximately 5 mm and the wall thickness is 0.8 mm. The tube is prepared for testing as described above. The length of the tube between the end clamp 23 and the seal 15 to the stainless steel tube 13 attached to the Dewar cap is 118 mm. The tube 50 is positioned as a straight tube hanging from the stainless steel tube 13 as depicted in FIG. 4a.

With the flow control valve 17 in the open position, the ullage is pressurised between 350 and 400 mbar. Flow of LN2 is confirmed by the wetting of the paper in front of the exit port.

### EXAMPLE 1 (d)

A tube is constructed from a sheet of paper hand towel (2 ply C-fold hand towel, re-order code 280242, Kruger Tissue Ind. Ltd., Manchester House, Church Stretton, England) possessing a thickness of 0.2 mm. The sheet is rolled into a tube, rolling from the lengthwise edge. A tube is constructed of eight layers and constrained in that shape by helically wrapping PTFE sewing thread (RASTEX®), Part Number S012T1, W.L. Gore and Associates, Inc., Elkton, Md.) once up and down the length of the tube. The distance between consecutive wraps is about 8 mm. The outer diameter is 5.5 mm and the wall thickness is 1.1 mm. The tube is prepared for testing as described above. The length of the tube between the end clamp 23 and the seal 15 to the stainless steel tube 13 attached to the Dewar cap is 129 mm. The tube is positioned as a straight tube 50 hanging from the stainless steel tube 13 as depicted in FIG. 4a. With the flow control valve 17 in the open position, the ullage is pressurised between 350 and 400 mbar. Flow of LN2 is confirmed by the wetting of the paper in front of the exit port.

### EXAMPLE 1 (e)

A tube is constructed using four porous sintered brass mufflers 30 (sintered pneumatic muffler, part number U-M5, M5 thread, Festo AG, Esslingen, Germany), as depicted in FIG. 2. The two pairs of mufflers are connected with pneumatic tubing 31 possessing an inner diameter of approximately 8 mm (Festa AG Esslingen Germany). The outer diameter of the porous muffler is 8.6 mm. Four stainless steel clamps 32 connect the muffler assemblies to clear plastic tubing 34 (6.35 mm outer diameter, approximately 4.4 mm inner diameter Norgen Ltd. Lichfield England). One end of the tube is terminated with a close-ended plug 33. The tube is prepared for testing as described above. The total length of the muffler sections is 33 mm.

The tube is positioned as a straight tube hanging from the stainless steel tube 13 as depicted in FIG. 4a.

With the flow control valve 17 in the open position, the ullage is pressurised between 350 and 400 mbar. The absence of flow of LN2 is confirmed by the lack of wetting of the paper in from of the exit port. The test is repeated, this time beginning with the Dewar completely filled with LN2. The flow control valve is opened and the pressure is increased to between 350 and 400 mbar. Flow of LN2 is confirmed by the wetting of the paper in front of the exit port. The flow, however, ceases once the level of the LN2 dropped to approximately point A on the tube as indicated in FIG. 2.

### EXAMPLE 1 (f)

A tube is constructed from a rectangular block of acoustic melamine open cell foam (BASOTECT®, BASF Aktiengesellschaft, Ludwigshafen, Germany), that is a macroporous material. A 4 mm diameter hole is bored along the lengthwise centerline with a stainless steel cutting tube of 4 mm outer diameter. The rectangular cross-section of the block has dimensions of 20 and 23 mm. The tube is prepared for testing as described above. The tube is connected to the Dewar cap 14 of FIG. 1 with a ⅛ inch (3.175 mm) NPT fitting as a replacement for the stainless steel tube 13. The length of the tube between the end clamp 23 and the seal 15 to the NPT fitting attached to the Dewar cap (as shown in FIG. 1) is 130 mm. The tube is positioned to hang straight as depicted in FIG. 4a.

With the flow control valve in the open position, the ullage is pressurised between 350 and 400 mbar. The absence of flow of LN2 is confirmed by the lack of wetting of the paper in front of the exit port.

### EXAMPLE 1 (g)

One inch diameter GORE-TEX® Joint Sealant (W.L. Gore & Associates, Inc., Elkton, Md.) is obtained. This article is microporous expanded PTFE beading 60. As illustrated in FIG. 6 of the drawings, a section of heat shrink tubing 62 is heat-shaped in order to provide a connection between the joint sealant 60 and a dip tube connector pipe fitting 64. The heat shrink tubing 62 is secured to the dip tube connector pipe fitting with a hose clamp 66. The joint sealant 60 is inserted into and glued to the inside of the heat shrink tubing using Silastic 734 RTV Sealant (Dow Corning, Munich) 68. The pipe fitting 64 is connected to the liquid delivery port of a Dewar lid. The joint sealant 60 is positioned to hang straight in the Dewar.

The Dewar is half-filled with LN2. With the flow control valve in the open position and the Dewar in the upright position, the ullage is pressurised to 600 mbar. The absence of flow of LN2 is confirmed by the lack of wetting of paper placed in front of the exit port. Additional LN2 is added to the Dewar until the liquid level is high enough to completely submerge the exposed joint sealant 60.

With the flow control valve in the open position and the Dewar in the upright position, the ullage is pressurised to 350 mbar. Flow of LN2 is confirmed by the wetting of the paper in front of the exit port. The rate of flow soon diminishes to a steady dripping out of the exit port. Most of the LN2 remains in the Dewar after the flow ceases.

The joint sealant, therefore, delivers LN2, but not as effectively as preferred embodiments of the present invention which deliver substantially more LN2.

### EXAMPLE 2

Another length (315 mm) of the tube of Example 1 (b) is tested in which the pressure driving force is provided by drawing a vacuum inside the tube 50 as depicted in FIG. 3. Liquid nitrogen 56 is contained in an open Dewar 55 and the tube 50 is positioned into a loop as shown FIG. 3, such that 155 mm of the 315 mm length is immersed in LN2. The flow of LN2 through the tube is confirmed by observing the liquid in the clear tubing 53. Liquid nitrogen delivery is observed both when the end of the tube is folded over and secured with a clamp 57 as shown in FIG. 3 and when left open to the surrounding vapour or atmosphere. The flow through the tube is observed even under a vacuum so small that the indicator needle of the gage does not move from the zero position. Should the use of a higher vacuum be desired, the tube may need to be supported to prohibit collapse.

Various configurations of the tube can be employed to ensure that the tube is in contact with the liquid in all positions of the Dewar. With this tube arrangement, the Dewar will preferentially deliver liquid regardless of the position of the Dewar.

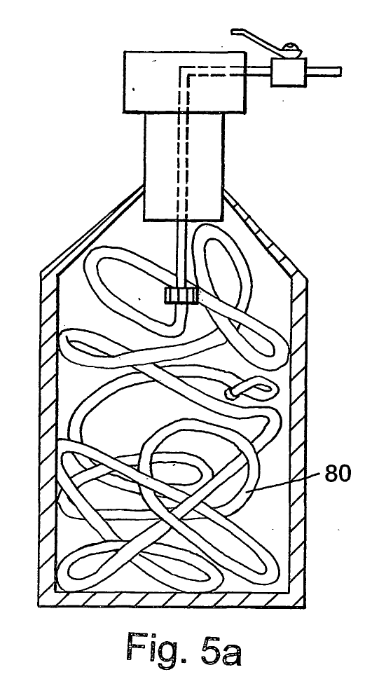

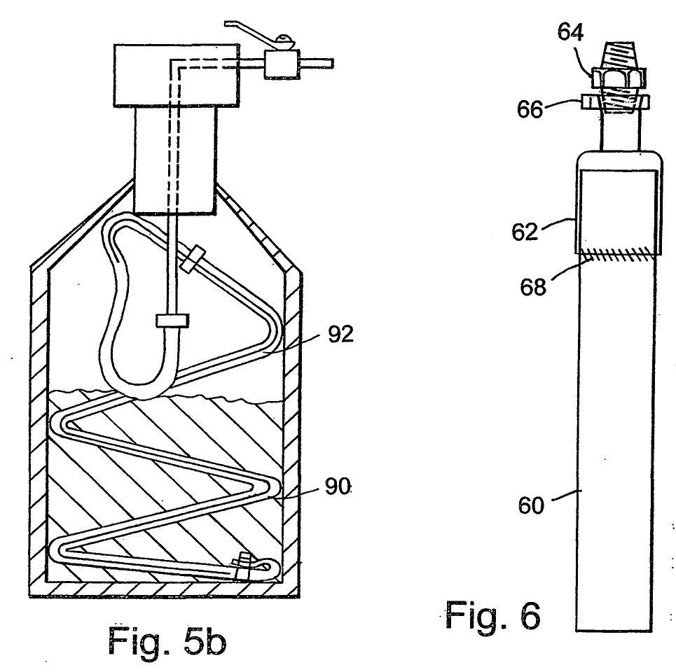

Some further tube configurations are illustrated in FIGS. 5A and 5B of the drawing, FIG. 5A illustrating a relatively long randomly configured closed-end tube 80, FIG. 5B illustrating a coiled tube 90 supported on a coiled spring 92 located within the tube 90 to maintain its preferred form.

While particular embodiments of the present invention have been illustrated and described herein, the present invention should not be limited to such illustrations and descriptions. It should be apparent that changes and modifications may be incorporated and embodied as part of the present invention within the scope of the following claims.

1. A cryogenic fluid delivery system comprising:
a sealed container capable of containing a cryogenic liquid, said container having at least one outlet; and
a polymeric microporous shaped article attached to said outlet and being arranged such that, in use, at least part of the surface of the article is in contact with cryogenic liquid in the container.

2. The system of claim 1 wherein the shaped article is in the form of a tube having at least a first end and a second end.

3. The system of claim 1 wherein the shaped article is in the form of a bladder.

4. The system of claim 1 wherein the shaped article is in the form of a bead.

5. The system of claim 1 wherein the shaped article is in the form of at least two coaxial cylinders defining at least one annulus therebetween.

6. The system of claim 1 wherein the polymer comprises polytetrafluoroethylene (PTFE).

7. The system of claim 6 wherein the PTFE is an expanded PTFE (ePTFE).

8. The system of any claim 1 to 5 wherein the microporous shaped article comprises a cellulosic material.

9. The system of claim 1 wherein the container is a Dewar.

10. The system of claim 1 wherein the system is arranged to provide cryogenic liquid at said at least one outlet.

11. The system of claim 10 wherein the system is arranged to deliver cryogenic liquid when the container is in any attitude from normal orientation.

12. The system of claim 2 wherein one end of the tube is closed.

13. The system of claim 2 wherein the tube is in the form of a coil.

14. The system of claim 2 wherein the tube is randomly distributed within the container.

15. The system of claim 1 wherein the shaped article is supported by at least one structural member.

16. An improved cryogenic liquid container and delivery system capable of delivering cryogenic liquid in any attitude of the container and comprising:
a sealed container capable of containing a cryogenic liquid, said container having at least one outlet; and
a polymeric microporous shaped article attached to said outlet and being arranged such that, in use, at least part of the surface of the article is in contact with cryogenic liquid inside the container.

17. The system of claim 16 wherein the microporous shaped article comprises a tube having at least a first end and a second end.

18. The system of claim 17 wherein the tube is in the form of a coil.

19. The system of claim 17 wherein the tube is randomly distributed within the container.

20. The system of claim 17 wherein at least one end of the tube is closed.

21. The system of claim 16 wherein the microporous shaped article comprises a bladder.

22. The system of any of claims 16 to 21 wherein the polymer comprises PTFE.

23. The system of claim 23 wherein the PTFE comprises expanded PTFE (ePTFE).

24. The system of any preceding claim wherein means is provided to create a positive pressure differential between the interior of the container and the outlet.

25. The system of claim 24 wherein said means is operable to pressurise the interior of the container.

26. The system of claim 25 wherein said means is a pump.

27. The system of claim 26 wherein said means is adapted to effect evaporation of liquid cryogen within the container and thus pressurise the container.

28. The system of claim 26 wherein said means is adapted to introduce pressurised gas into the container.

29. The system of claim 25 wherein said means is adapted to apply a vacuum to the outlet of the container.

30. The system of any preceding claim wherein the microporous shaped article is adapted to act as a filtering device.

31. The system of any of claims 16 to 30 wherein the container is a Dewar.

32. An improved cryogenic liquid container and dispensing system capable of delivering cryogenic liquid in any orientation of the container and comprising:
a sealed Dewar containing a cryogenic liquid, said Dewar having at least one outlet;
a tube comprising microporous expanded PTFE having at least a first end and a second end and attached to said outlet; and
wherein said tube is in contact, along at least part of its surface, with said cryogenic liquid within said Dewar.

33. A cryogenic fluid delivery system comprising:
a container capable of containing a cryogenic liquid, said container having at least one outlet; and
a polymeric microporous shaped article operatively associated said outlet and being arranged such that, in use, at least part of the surface of the article is in contact with cryogenic liquid in the container.

34. A method of delivering cryogenic fluid, the method comprising:
providing a container containing a cryogenic liquid;
coupling a polymeric microporous shaped article to an outlet of the container such that at least part of the surface of the article is in contact with said cryogenic liquid; and
delivering cryogenic fluid from the container through the article.

35. The method of claim 34, wherein cryogenic liquid is provided at said container outlet.

36. The method of claim 35, wherein cryogenic liquid is provided at said container outlet when said container is in any attitude from normal orientation.

37. The method of claim 33, 34 or 35, wherein a positive pressure differential is provided between the interior of the container and the outlet.

38. The method of any of claims 33 to 37, wherein the fluid is filtered by passing through the microporous shaped article.

39. A dip tube for extending into a cryogenic fluid container and for delivering cryogenic fluid out of the container, the tube defining a wall and at least a portion of the wall having a polymeric microporous structure, whereby cryogenic fluid may pass through said portion of the wall.
